(19) United States
(12) Patent Application Publication
(10) Pub. No.: US 2026/0109804 A1
(43) Pub. Date: Apr. 23, 2026

(54) PROCESS FOR MAKING POLYURETHANE

(71) Applicant: ROGERS CORPORATION, Chandler, AZ (US)

(72) Inventor: Joseph Puglisi, Ashford, CT (US)

(21) Appl. No.: 19/356,527

(22) Filed: Oct. 13, 2025

Related U.S. Application Data
(60) Provisional application No. 63/709,558, filed on Oct. 21, 2024.

(51) Int. Cl. C08G 18/22; C08G 18/08; C08G 101/00

(52) U.S. Cl. CPC C08G 18/222; C08G 18/0842; C08G 18/14; C08G 2101/00; C08G 2110/0066

(57) ABSTRACT

A process for making polyurethane includes dissolving a metal acetyl acetonate catalyst in a solvent to form a catalyst solution including greater than 0.25 to 42 weight percent, or 4.8 to 42 weight percent, of metal acetyl acetonate catalyst, based on a total weight of the catalyst solution; combining the catalyst solution, a polyol, and an isocyanate to form a reactive mixture; and curing the reactive mixture to form polyurethane.

### CROSS REFERENCE TO RELATED APPLICATION

This application claims the benefit of U.S. Application No. 63/709,558, filed Oct. 21, 2024, which is incorporated by reference in its entirety herein.

### BACKGROUND

Provided is a process for making polyurethane and the product produced therefrom. For example, provided is a process useful in the production of polyurethane foams.

Catalyst for the production of polyurethane can be made by grinding and milling metal acetyl acetonate catalyst into a polyol and dissolving the metal acetyl acetonate in the polyol. Grinding and dissolution of the metal acetyl acetonate can be challenging and even with grinding, the metal acetyl acetonate can have low solubility in the polyol.

### SUMMARY

A process for making polyurethane includes dissolving a metal acetyl acetonate catalyst in a solvent to form a catalyst solution including greater than 0.25 to 42 weight percent, or 4.8 to 42 weight percent, of metal acetyl acetonate catalyst, based on a total weight of the catalyst solution; combining the catalyst solution, a polyol, and an isocyanate to form a reactive mixture; and curing the reactive mixture to form polyurethane.

A process for making polyurethane includes dissolving a metal acetyl acetonate catalyst in a solvent including benzyl alcohol to form a catalyst solution; combining the catalyst solution, a polyol, and an isocyanate to form a reactive mixture; and curing the reactive mixture to form polyurethane.

The above described and other features are exemplified by the following detailed description.

### DETAILED DESCRIPTION

Incorporation of metal acetyl acetonate catalyst during the production of polyurethane can be accomplished by dissolving the metal acetyl acetonate in polyol used in the production of the polyurethane. For example, 0.25 weight percent (wt %) of ferric acetyl acetonate can be dissolved in a polyol.

Metal acetyl acetonate catalyst can have low solubility in polyol used as a carrier for the metal acetyl acetonate catalyst, and a high level of catalyst can be desired during production of polyurethanes. Provided is a process in which metal acetyl acetonate catalyst is dissolved in a solvent having high solubility capability with a metal acetyl acetonate, such as, for example, diacetone alcohol, furfuryl alcohol, acetone, ethyl acetonacetate, benzyl alcohol, acetyl acetone, or a combination thereof, which is then used in the production of a polyurethane.

With the disclosed process, much higher levels of catalyst can be incorporated into the polyurethane and ease of processing can be improved. Advantages of the disclosed process include lower cost and easier processing of the catalyst, options to increase catalyst loading without adding higher levels of carrier polyol, potential to cure and run production lines faster, enabling higher production line capacity and lower product costs, improving ease of addition of catalyst to suitable streams or blends without disrupting the blend, and higher levels of consistency during production.

The process for making polyurethane can include dissolving a metal acetyl acetonate catalyst in a solvent to form a catalyst solution including greater than 0.25 to 42 wt %, for example, 1 to 30 wt %, metal acetyl acetonate catalyst, based on a total weight of the catalyst solution; combining the catalyst solution, a polyol, and an isocyanate to form a reactive mixture; and curing the reactive mixture to form polyurethane. The process can further include mechanical frothing or chemical foaming. The solvent can include, for example, benzyl alcohol and optionally additionally include acetyl acetone.

The process for making polyurethane can include dissolving a metal acetyl acetonate catalyst in a solvent including benzyl alcohol to form a catalyst solution; combining the catalyst solution, a polyol, and an isocyanate to form a reactive mixture; and to curing the reactive mixture to form polyurethane. The solvent can optionally additionally include acetyl acetone.

### Solvent

The present inventor surprisingly discovered that a solvent having high solubility capability with a metal acetyl acetonate can allow for increased catalyst loading in the production of polyurethane, which can allow for increased formulating flexibility. Exemplary solvents include diacetone alcohol, furfuryl alcohol, acetone, ethyl acetonacetate, benzyl alcohol, acetyl acetone, or a combination thereof.

The solvent can include zero or one reactive (e.g., alcohol) group. For example, benzyl alcohol includes one alcohol group but may not typically be used in urethane production. In contrast, based on reported solubility, diols, and similar monols, such as dipropylene glycol would not be expected to be good solvents for dissolution of a metal acetyl acetonate.

In contrast to dipropylene glycol or other hydroxyl containing compounds such as diethylene glycol and 2-methyl-1,3-propanediol that can have solubility of less than 1 wt %, for example, 0.25 wt %, for ferric acetyl acetonate, benzyl alcohol was surprisingly found to have a solubility of about 25 wt %. Benzyl alcohol can react into the system, and concerns associated with fogging and outgassing can be avoided. The solvent can participate in the reaction and become part of the final product. Dissolution of ferric acetyl acetonate by benzyl alcohol can quickly be achieved, for example, with 2.8 grams (g) of benzyl alcohol per 1.0 gram of ferric acetyl acetonate.

The metal acetyl acetonate catalyst can be dissolved in the solvent to form a catalyst solution including greater than 0.25 to 42 wt %, for example, 1 to 30 wi % metal acetyl acetonate catalyst, based on a total weight of the catalyst solution. In contrast, the catalyst solution can include 2 to 42 wt %, 2.5 to 42 wt %, 3 to 42 wt %, 4 to 42 wt %, 4.8 to 42 wt %, 5 to 42 wt %, 10 to 42 wt %, 15 to 42 wt %, 2 to 30 wt %, 2.5 to 30 wt %, 3 to 30 wt %, 4 to 30 wt %, 4.8 to 30 wt %, 5 to 30 wt %, 10 to 30 wt %, 15 to 30 wt %, 2 to 25 wt %, 2.5 to 25 wt %, 3 to 25 wt %, 4 to 25 wt %, 4.8 to 25 wt %, 5 to 25 wt %, 10 to 25 wt %, or 15 to 25 wt %, metal acetyl acetonate catalyst, based on a total weight of the catalyst solution.

### Metal Acetyl Acetonate Catalyst

A metal acetyl acetonate catalyst that can be used to catalyze the reaction of a isocyanate component with an active hydrogen-containing component during production of the polyurethane can have the following structure:

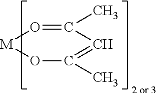

wherein M is aluminum, barium, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, titanium, vanadium, yttrium, zinc and zirconium.

### Acetyl Acetone

Acetyl acetone (2,4-pentanedione) can act as a delay mechanism to delay the catalytic action of the metal acetyl acetonate, which can be highly catalytic at relatively low temperatures (e.g., room temperature). High catalytic activity at relatively low temperature can lead to premature cure. The boiling point of acetyl acetone is 139° C. The acetyl acetone can act to delay and/or slow the catalytic action of the metal acetyl acetonate until the polyurethane is heated such that the acetyl acetone is substantially driven off and a now desirable, relatively fast cure at an elevated temperature then takes place. Acetyl acetone (as an inhibitor) can be driven off with rising temperature to permit a final, complete cure late in the processing cycle.

The ratio of metal acetyl acetonate to acetyl acetone can be about 1:1 to about 20:1, for example, about 2:1 to about 20:1, on a weight basis. As used herein, a “catalyst system” can refer to the metal acetyl acetonate catalyst or combination of metal acetyl acetonate catalyst and acetyl acetone, if present.

The acetyl acetone can delay or inhibit the reactive metal acetyl acetonate at lower temperatures appropriate to achieve proper mixing and casting. The acetyl acetone can provide heat latency, which can allow time for mixing, casting and other procedures, and can avoid deleterious premature curing during low temperature processing. However, as the reactive mixture is cured, for example, in several heating zones, and the temperature of the reactive mixture rises, the acetyl acetone can be driven off, and the metal acetyl acetonate allowed to resume high reactivity and provide a very high level of catalysis at the end of the polyurethane reaction. High reactivity late in the processing cycle can be advantageous and provide improved physical properties such as compression set.

### Polyurethane

A method of forming a cured polyurethane includes combining an active hydrogen-containing component (also referred to herein as “Part A”) including a polyol and an isocyanate component (also referred to herein as “Part B”) including a polyisocyanate to form an uncured polyurethane; and curing the uncured polyurethane to form the cured polyurethane.

Polyurethanes can be formed from a reactive composition including an organic isocyanate-containing component reactive with an active hydrogen-containing composition, a surfactant, and a catalyst. Each of the organic isocyanate component and the active hydrogen-containing component can include one or more different types of each type of compound.

The organic polyisocyanate component used in the preparation of polyurethanes includes at least a polyisocyanate having the general formula Q(NCO)ᵢ, wherein i is an integer having an average value of two or greater, and Q is an organic radical having a valence of i. Q can be a substituted or unsubstituted group (for example, an alkane or an aromatic group of the appropriate valency). Q can be a group having the formula Q¹-Z-Q¹ wherein Q¹ is an alkylene or arylene group and Z is —O—, —O-Q¹-S—, —CO—, —S—, —S-Q¹-S—, —SO—, or —SO₂—. Q can represent a polyurethane radical having a valence of i.

Examples of suitable polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl) methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, or polymeric isocyanates such as polymethylene polyphenylisocyanate.

The active hydrogen-containing component includes at least one multi-functional active hydrogen containing compound, which can be a polyamine or a polyol, for example a polyether polyol, a polyester polyol, a lower molecular weight polyol, or a combination thereof. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, or castor oil polyols. Suitable dicarboxylic acids and derivatives of dicarboxylic acids that are useful for producing polycondensation polyester polyols are aliphatic or cycloaliphatic dicarboxylic acids such as glutaric, adipic, sebacic, fumaric or maleic acids; dimeric acids; aromatic dicarboxylic acids such as phthalic, isophthalic or terephthalic acids; tribasic or higher functional polycarboxylic acids such as pyromellitic acid; as well as anhydrides or second alkyl esters, such as maleic anhydride, phthalic anhydride or dimethyl terephthalate. The polymers of cyclic esters can also be used. The preparation of cyclic ester polymers from at least one cyclic ester monomer is exemplified by U.S. Pat. Nos. 3,021,309 through 3,021,317; 3,169,945; and 2,962,524. Suitable cyclic ester monomers include but are not limited to 8-valerolactone; ∈-caprolactone; zeta-enantholactone; the monoalkyl-valerolactones, e.g., the monomethyl-, monoethyl-, and monohexyl-valerolactones. The polyester polyol may include a caprolactone-based polyester polyol, an aromatic polyester polyol, an ethylene glycol adipate-based polyol, or a combination thereof. The polyester polyols can be made from, for example, ∈-caprolactones, adipic acid, phthalic anhydride, and terephthalic acid or dimethyl esters of terephthalic acid.

Polyether polyols can be obtained by the chemical addition of alkylene oxides, such as ethylene oxide, propylene oxide, or a combination thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1, 10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy) diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1, 1-tris[2-hydroxyethoxy)methyl]-ethane, 1,1,1-tris[2-hydroxypropoxy)-methyl]propane, diethylene glycol, dipropylene glycol, pentaerythritol, sorbitol, sucrose, lactose, alpha-methylglucoside, alpha-hydroxyalkylglucoside, a novolac polymer, phosphoric acid, benzenephosphoric acid, a polyphosphoric acid such as tripolyphosphoric acid and tetrapolyphosphoric acid, ternary condensation products, and the like. The alkylene oxides used in producing polyoxyalkylene polyols can have 2 to 4 carbon atoms, or 2 to 3 carbon atoms. Exemplary alkylene oxides are propylene oxide and mixtures of propylene oxide with ethylene oxide.

Polytetramethylene polyether diol or glycol, polyether diols with a weight average molecular weight (Mw) of 500 to about 4,000, or 1,000 and 3,000, and mixtures with one or more other polyols, can be specifically mentioned. The polyols listed above can be used per se as the active hydrogen component.

A specific class of polyether polyols is represented generally by the formula R[(OCₙH₂ₙ), OH]ₐ wherein R is hydrogen or a polyvalent hydrocarbon radical; a is an integer (i.e., 2 to 8) equal to the valence of R, n in each occurrence is an integer from 2 to 4 inclusive (for example, 3) and z in each occurrence is an integer having a value of 2 to 200, for example, 15 to 100. Specifically, the polyether polyol can have the formula R[(OC₄H₈)_{z}OH]₂, wherein R is a divalent hydrocarbon radical and z in each occurrence is 2 to about 40, specifically 5 to 25.

An active hydrogen-containing material that can be used is a polymer polyol composition obtained by polymerizing ethylenically unsaturated monomers with a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride, and other ethylenically unsaturated monomers as identified and described in the above-mentioned U.S. Patent. Suitable polyols include those listed and described above and in U.S. Pat. No. 3,383,351. The active hydrogen-containing component may also contain polyhydroxy-containing compounds such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Patent No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The active-hydrogen-containing component, for example, the polyol component, can further include a very low molecular weight chain extender, cross-linking agent, or combination thereof. Exemplary chain extenders and cross-linking agents include alkane diols, dialkylene glycols and/or polyhydric alcohols, for example, triols and tetrols, having a molecular weight from about 200 to 400 Dalton. The chain extenders and cross-linking agents can be used, for example in an amount of 0.5 to 20 percent by weight, or 10 to 15 percent by weight, based on the total weight of the active-hydrogen-containing component. Other chain extenders can be a very low molecular weight (below about 200 Dalton) diol, including but not being limited to, dipropylene glycol, 1,4-butanediol, 2-methyl-1,3-propanediol, and 3-methyl-1,5-pentane diol.

In an embodiment, the active hydrogen-containing component is a polyol component that includes a higher molecular weight polyether polyol, for example a polyether polyol having a Mw of 400 to about 8,000, or 1,000 and 3,000, and a hydroxy number of 14 to 280; a polyester polyol, such as a polycaprolactone-based polyol, or a combination thereof, and a very low molecular weight polyol as a chain extender or crosslinking agent. Exemplary polyether polyols include polyoxyalkylene diols and triols, and polyoxyalkylene diols and triols with polystyrene and/or polyacrylonitrile grafted onto the polymer chain, or a combination thereof. A triol can be present, such as a polycaprolactone triol having an Mw of 50 to 3,000 and a hydroxy number can be 200 to 2,000, for example, 500 to 1,500. The triol can be a polycaprolactone triol.

The average weight percent hydroxy, based on the hydroxyl numbers of the hydroxyl-containing compounds (including all polyols or diols), including other cross-linking additives, surfactants, catalysts, and pigments, if used, can be 28 to 1000, or 28 to 500, or 28 to 300, or 50 to 300, depending on the desired firmness or softness of the polyurethane. The hydroxyl number is defined as the appropriate number of milligrams of potassium hydroxide for the complete neutralization of the hydrolysis product of the fully acetylated derivative prepared from 1 gram of polyol or polyol component with or without other cross-linking additives.

The reactive composition can include a surfactant that can stabilize the reactive composition before it is cured. The surfactant can include an organosilicone surfactant. The organosilicone can include a copolymer including or consisting essentially of SiO₂ (silicate) units and (CH₃)₃SiO_{0.5} (trimethylsiloxy) units in a molar ratio of silicate to trimethylsiloxy units of 0.8:1 to 2.2:1, or 1:1 to 2.0:1. The organosilicone can include a partially cross-linked siloxane-polyoxyalkylene block copolymer, wherein the siloxane blocks and polyoxyalkylene blocks are linked by silicon to carbon, or by silicon to oxygen to carbon. The surfactant can be present in an amount of 0.5 to 10 wt %, or 1 to 6 wt %, based on the total weight of the active hydrogen component. The surfactant can be present in an amount of 0.1 to 7 wt %, or 2 to 5 wt %, based on a total weight of the uncured polyurethane.

Other, optional additives can be added to the reactive composition. For example, the additive can include a desiccant, dyes, pigments (for example, titanium dioxide or iron oxide), antioxidants, antiozonants, UV stabilizers, or a combination thereof.

### Reactive Mixture

Combining the catalyst solution, the polyol, and the isocyanate to form the reactive mixture can include combining the catalyst solution and the polyol to form an intermediate mixture and combining the intermediate mixture and the isocyanate to form the reactive mixture. The intermediate mixture can include, for example, greater than 0.0020 to 0.10 wt % metal acetyl acetonate catalyst, based on a total weight of the intermediate mixture.

Combining the catalyst solution, the polyol, and the isocyanate to form the reactive mixture can include combining the catalyst solution and the isocyanate to form an intermediary mixture and combining the intermediary mixture and the polyol to form the reactive mixture. Combining the catalyst solution, the polyol, and the isocyanate to form the reactive mixture can include conveying the catalyst solution in a separate stream and combining the separate stream and the polyol and the isocyanate to form the reactive mixture. The separate stream including the catalyst solution can optionally further include other additives, for example, colorant, surfactant, or a combination thereof.

The reactive mixture including the catalyst solution, the polyol, and the isocyanate can include, for example, 0.0015 to 0.075 wt % metal acetyl acetonate catalyst, based on a total weight of the reactive mixture. The amount of metal acetyl acetonate catalyst in the uncured polyurethane can be 0.0015 to 0.075 wt %, based on a total weight of the uncured polyurethane.

### Foam

The disclosed polyurethane can be a foam, which can be mechanically frothed, physically or chemically blown, or both. The polyurethane foams can be made by casting a mechanically frothed composition. For example, the reactive precursors of the polyurethane can be mixed and mechanically, frothed, then cast to form a layer, and cured. Curing can include heating.

Physical blowing agents can be used alone or as mixtures with each other or with one or more chemical blowing agents. Physical blowing agents can be selected from a broad range of materials, including hydrocarbons, ethers, esters and partially halogenated hydrocarbons, ethers, and esters, and the like. Typical physical blowing agents have a boiling point of −50 to 100° C., or −50 to 50° C. Exemplary physical blowing agents include CFC's (chlorofluorocarbons) (for example, 1,1-dichloro-1-fluoroethane, 1,1-dichloro-2,2,2-trifluoro-ethane, monochlorodifluoromethane, or 1-chloro-1,1-difluoroethane); FC's (fluorocarbons) (for example, 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, or pentafluoroethane); FE's (fluoroethers) (for example, methyl-1,1,1-trifluoroethylether or difluoromethyl-1,1,1-trifluoroethylether); or hydrocarbons (for example, n-pentane, isopentane, or cyclopentane). The physical blowing agent can include at least one of carbon dioxide, ethane, propane, n-butane, isobutane, pentane, hexane, butadiene, acetone, methylene chloride, any of the chlorofluorocarbons, hydrochlorofluorocarbons, or hydrofluorocarbons. As with the chemical blowing agents, the physical blowing agents can be used in an amount sufficient to give the resultant foam the desired bulk density. Typically, physical blowing agents are used in an amount of 5 to 50 wt %, or 10 to 30 wt %, based on the total weight of the reactive composition.

If a chemical blowing agent is used, it can include at least one of water, an azo compound (for example, azoisobutyronitrile, azodicarbonamide (i.e. azo-bis-formamide), or barium azodicarboxylate); a substituted hydrazine (for example, diphenylsulfone-3,3′-disulfohydrazide, 4,4′-hydroxy-bis-(benzenesulfohydrazide), trihydrazinotriazine, or aryl-bis-(sulfohydrazide)); a semicarbazide (for example, p-tolylene sulfonyl semicarbazide, or 4,4′-hydroxy-bis-(benzenesulfonyl semicarbazide)); a triazole (for example, 5-morpholyl-1,2,3,4-thiatriazole); an N-nitroso compound (for example, N,N′-dinitrosopentamethylene tetramine or N,N-dimethyl-N,N′-dinitrosophthalmide); benzoxazine (for example, isatoic anhydride); or a mixture (for example, a sodium carbonate/citric acid mixture). The chemical blowing agent can include water. The blowing agent can include at least one of an ammonium salt, a phosphate, a polyphosphate, a borate, a polyborate, a sulphate, a urea, a urea-formaldehyde resin, a dicyandiamide, or a melamine.

The amount of the foregoing chemical blowing agents can vary depending on the agent and the desired foam density. Chemical blowing agents can be used in an amount of, for example, 0.1 to 10 wt %, based on the total weight of the reactive composition. The decomposition products formed during the decomposition process can be physiologically safe, and that may not significantly adversely affect the thermal stability or mechanical properties of the foamed polyurethane.

The polyurethane foam can be produced by mechanically mixing the reactive composition (including the isocyanate component, the active hydrogen-containing component, a froth-stabilizing surfactant, the catalyst, and other optional additives) with a froth-forming gas. The frothed mixture can be fed onto a release liner and spread to a layer of desired thickness by a doctoring blade or other suitable spreading device. The gauged layer of the frothed mixture can then be delivered to one or more heating zones. After the heating zone, the formed polyurethane layer can be passed to a cooling zone.

For example, in the production of polyurethane foams, the reactive components of the polyurethane foam-forming composition can be formulated in two parts, one part (“Part A”) containing the active hydrogen-containing component, the catalyst, the surfactant, and if used the inhibitor, and a chemical blowing agent; and the other part (“Part B”) containing the organic isocyanate component. The parts can be metered, mixed, and cast, for example, into a mold or a continuous coating line. The foaming and curing then occurs either in the mold or on the continuous coating line. In a method of production, the reactive components of the polyurethane foam-forming composition can be introduced into an extruder together with a chemical blowing agent, a physical blowing agent, or other additives if used. The catalyst can then be metered into the extruder to start the foaming and curing reaction. The use of physical blowing agents such as liquid carbon dioxide or supercritical carbon dioxide in conjunction with chemical blowing agents such as water can give rise to foam having much lower densities.

The following examples are provided to illustrate the present disclosure. The examples are merely illustrative and are not intended to limit devices made in accordance with the disclosure to the materials, conditions, or process parameters set forth therein.

### Examples

Catalyst systems were made and tested. Gel time performance, which was approximately the same between the catalyst systems tested, is an indicator of catalytic activity. Results are shown in Table 1.

TABLE 1

| | Gel Time |
|---|---|
| | Perfor- |
| Catalyst System | mance |
| 2.5 grams (ferric acetyl acetonate dissolved in 1,000 g of | 2.35 minutes |
| polyether diol | |
| 2.5 grams (g) ferric acetyl acetonate pre-dissolved into 25 g | 2.43 minutes |
| benzyl alcohol, then added to 975 g of polyether diol (9.1 | |
| weight percent (wt %) ferric acetyl acetonate based on total | |
| amount of ferric acetyl acetonate and benzyl alcohol) | |
| 2.5 g ferric acetyl acetonate pre-dissolved into 12 g benzyl | 2.33 minutes |
| alcohol, then added to 988 g of polyether diol (17.2 wt % | |
| ferric acetyl acetonate based on total amount of ferric | |
| acetyl acetonate and benzyl alcohol) | |

Foams were formed using (i) a comparative catalyst system including 2.5 g of ferric acetyl acetonate and 2.2 g of acetyl acetone (“Comparative Example 1”) and (ii) a catalyst system including 2.5 g ferric acetyl acetonate and 2.2 g of acetyl acetone pre-dissolved into 12 g benzyl alcohol (“Example 1”). For both Comparative Example 1 and Example 1, 985.5 g of polyether diol was used.

TABLE 2

| | Specification | Comparative | |
|---|---|---|---|
| | Range | Example 1 | Example 1 |
| Thickness | | | |
| Inches | | 0.069 | 0.067 |
| Centimeters | | 0.18 | 0.17 |
| Density | | | |
| Pounds per cubic foot | 9.9 to 10.1 | 9.7 | 10.0 |
| Kilograms per cubic meter | 158.6 to 161.8 | 155.4 | 160.2 |
| Compression force deflection | | | |
| (CFD) at 25% | | | |
| Pounds per square inch (psi) | 4.0 to 8.0 | 6.3 | 6.0 |
| Kilopascals (kPa) | 27.6 to 55.2 | 43.4 | 41.4 |
| Compression Set (%) | <10% | 4.7 | 3.4 |
| Tensile Strength | | | |
| psi | >50 | 91 | 92 |
| kPa | >344.7 | 627.4 | 634.3 |
| Elongation at Break (%) | >80% | 104 | 109 |
| Tear Strength (psi) | | | |
| psi | >7.0 | 8.4 | 9.0 |
| kPa | >48.3 | 57.9 | 62.1 |

Fogging testing, according to TSO 492, had a pass rating, identical to the control. Outgassing testing provided values similar to the control.

This disclosure further encompasses the following aspects.

Aspect 1: A process for making polyurethane, the process comprising: dissolving a metal acetyl acetonate catalyst in a solvent to form a catalyst solution comprising greater than 0.25 to 42 weight percent, or 4.8 to 42 weight percent, of metal acetyl acetonate catalyst, based on a total weight of the catalyst solution; combining the catalyst solution, a polyol, and an isocyanate to form a reactive mixture; and curing the reactive mixture to form polyurethane.

Aspect 2: The process of aspect 1, wherein the catalyst solution comprises 2.5 to 25 weight percent, or 4.8 to 25 weight percent, of the metal acetyl acetonate catalyst, based on a total weight of the catalyst solution.

Aspect 3: The process of aspect 1 or 2, wherein combining the catalyst solution, the polyol, and the isocyanate to form the reactive mixture comprises: combining the catalyst solution and the polyol to form an intermediate mixture; and combining the intermediate mixture and the isocyanate to form the reactive mixture.

Aspect 4: The process of any one of the preceding aspects, wherein the reactive mixture comprises 0.0015 to 0.075 weight percent of the metal acetyl acetonate catalyst, based on a total weight of the reactive mixture.

Aspect 5: The process of any one of the preceding aspects, wherein the solvent comprises diacetone alcohol, furfuryl alcohol, acetone, ethyl acetonacetate, benzyl alcohol, acetyl acetone, or a combination thereof.

Aspect 6: The process of any one of the preceding aspects, wherein the solvent comprises benzyl alcohol.

Aspect 7: The process of 6, wherein the solvent further comprises acetyl acetone.

Aspect 8: The process of any one of aspects 1 to 5, wherein the solvent comprises acetyl acetone.

Aspect 9: The process of any one of the preceding aspects, wherein the metal of the metal acetyl acetonate comprises aluminum, barium, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, titanium, vanadium, yttrium, zinc zirconium, or a combination thereof.

Aspect 10: The process of aspect 9, wherein the metal comprises iron (III).

Aspect 11: The process of any one of the preceding aspects, wherein the polyurethane comprises a foam.

Aspect 12: The process of aspect 11, further comprising mechanical frothing.

Aspect 13: The process of aspect 11, further comprising chemical foaming.

Aspect 14: A polyurethane formed by the process of any one of the preceding aspects.

Aspect 15: A process for making polyurethane, the process comprising: dissolving a metal acetyl acetonate catalyst in a solvent comprising benzyl alcohol to form a catalyst solution; combining the catalyst solution, a polyol, and an isocyanate to form a reactive mixture; and curing the reactive mixture to form polyurethane.

Aspect 16: The process of aspect 15, wherein the catalyst solution comprises 2.5 to 25 weight percent, or 4.8 to 25 weight percent, of the metal acetyl acetonate catalyst, based on a total weight of the catalyst solution.

Aspect 17: The process of aspect 15 or 16, wherein combining the catalyst solution, the polyol, and the isocyanate to form the reactive mixture comprises: combining the catalyst solution and the polyol to form an intermediate mixture; and combining the intermediate mixture and the isocyanate to form the reactive mixture.

Aspect 18: The process of any one of aspects 15 to 17, wherein the solvent further comprises acetyl acetone.

Aspect 19: The process of any one of aspects 15 to 18, wherein the polyurethane comprises a foam.

Aspect 20: A polyurethane formed by the process of any one of aspects 15 to 19.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. Thus, reference to “an” element in a claim followed by reference to “the” element is inclusive of one element and a plurality of the elements. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A process for making polyurethane, the process comprising:
dissolving a metal acetyl acetonate catalyst in a solvent to form a catalyst solution comprising greater than 0.25 to 42 weight percent of metal acetyl acetonate catalyst, based on a total weight of the catalyst solution;
combining the catalyst solution, a polyol, and an isocyanate to form a reactive mixture; and
curing the reactive mixture to form polyurethane.

2. The process of claim 1, wherein the catalyst solution comprises 2.5 to 25 weight percent of the metal acetyl acetonate catalyst, based on a total weight of the catalyst solution.

3. The process of claim 1, wherein combining the catalyst solution, the polyol, and the isocyanate to form the reactive mixture comprises:
combining the catalyst solution and the polyol to form an intermediate mixture; and
combining the intermediate mixture and the isocyanate to form the reactive mixture.

4. The process of claim 1, wherein the reactive mixture comprises 0.0015 to 0.075 weight percent of the metal acetyl acetonate catalyst, based on a total weight of the reactive mixture.

5. The process of claim 1, wherein the solvent comprises diacetone alcohol, furfuryl alcohol, acetone, ethyl acetonacetate, benzyl alcohol, acetyl acetone, or a combination thereof.

6. The process of claim 1, wherein the solvent comprises benzyl alcohol.

7. The process of 6, wherein the solvent further comprises acetyl acetone.

8. The process of claim 1, wherein the solvent comprises acetyl acetone.

9. The process of claim 1, wherein the metal of the metal acetyl acetonate comprises aluminum, barium, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, titanium, vanadium, yttrium, zinc zirconium, or a combination thereof.

10. The process of claim 9, wherein the metal comprises iron (III).

11. The process of claim 1, wherein the polyurethane comprises a foam.

12. The process of claim 11, further comprising mechanical frothing.

13. The process of claim 11, further comprising chemical foaming.

14. A polyurethane formed by the process of claim 1.

15. A process for making polyurethane, the process comprising:
dissolving a metal acetyl acetonate catalyst in a solvent comprising benzyl alcohol to form a catalyst solution;
combining the catalyst solution, a polyol, and an isocyanate to form a reactive mixture; and
curing the reactive mixture to form polyurethane.

16. The process of claim 15, wherein the catalyst solution comprises 2.5 to 25 weight percent of the metal acetyl acetonate catalyst, based on a total weight of the catalyst solution.

17. The process of claim 15, wherein combining the catalyst solution, the polyol, and the isocyanate to form the reactive mixture comprises:
combining the catalyst solution and the polyol to form an intermediate mixture; and
combining the intermediate mixture and the isocyanate to form the reactive mixture.

18. The process of claim 15, wherein the solvent further comprises acetyl acetone.

19. The process of claim 15, wherein the polyurethane comprises a foam.

20. A polyurethane formed by the process of claim 15.
